(19) United States
(12) Patent Application Publication
(10) Pub. No.: US 2004/0094345 A1
(43) Pub. Date: May 20, 2004

(54) Operating means for a cruise control in vehicles

(75) Inventors: Ernst Hafner, Hagnau (DE); Peter Bubb, Grobenzell (DE); Matthias Gotz, Munich (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Automotive Electronics & Components GmbH & Co. KG

(21) Appl. No.: 10/634,676

(22) Filed: Aug. 5, 2003

(30) Foreign Application Priority Data
Aug. 7, 2002 (DE) 102 36 224.6

(51) Int. Cl. B60K 31/00

(52) U.S. Cl. 180/170

(57) ABSTRACT

The operating means has a touch-sensitive control surface with an alpha-numeric input field (12) onto which at least one number can be entered by tracing. The number thus entered is transmitted as a setpoint value to the cruise control by a setting function.

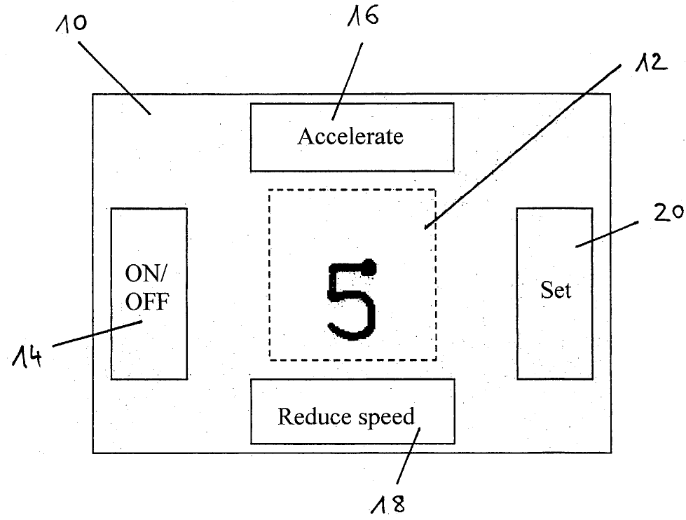

The invention relates to an operating means for a cruise control in vehicles.

Such operating means are designed according to the state of the art as drop arms, rocker switches or individual control buttons on the steering wheel. They are used to carry out the elementary control functions such as activate/deactivate, set, resume, accelerate and coast. In order to set a certain speed, the appropriate control element is actuated once the vehicle has reached this speed. After actuation of the control elements for the control functions of accelerate and coast, the most recently driven speed is established. In any case, setting a certain speed, e.g. in accordance with a given speed limit, calls for careful observation of the speed-ometer on the instrument panel of the vehicle.

With the operating means according to the invention, there is no need for eye contact with the speedometer of the vehicle in order to set a certain speed. The operating means according to the invention comprises a touch-sensitive control panel with at least one alphanumeric input field. At least one digit can be entered by tracing it onto the input field. The digit(s) thus entered is (are) transmitted as a setpoint value to the cruise control by a setting function.

The setting function preferably comprises a reading function that interprets symbols that have been entered with a fingertip by roughly tracing the digit onto the input field and that only accepts only plausible alphanumeric symbols.

Moreover, the input field is preferably surrounded by several control fields that can be haptically distinguished from each other, each of which is associated with a control function.

Additional features and advantages of the invention ensue from the following description of an advantageous embodiment, with reference to the appended drawing whose single figure shows a top view of a control surface of the operating means.

The control panel, which is designated in its entirety by the reference numeral 10, is touch-sensitive and can convert any (except for a fleeting) touch into an electric signal. Such control panels are known from portable computers (laptops, notebooks) as touch pads.

The control panel 10 can be arranged on the steering wheel of the vehicle, preferably on a steering wheel spoke or on the steering wheel hub, on a steering wheel satellite, on the center console or else in the area of the control field for the radio or climate-control system.

In the currently preferred embodiment, which is shown by way of an example, the control panel is generally rectangular and has a central alphanumeric input field 12. The input field 12 is surrounded by control fields 14, 16, 18, 20. The control field 14 is assigned to activating/deactivating the cruise control. The control fields 16, 18 initiate the functions “accelerate” and “reduce speed”. The control field 20 sets the speed that was entered onto the input field 12. i.e. it is transmitted as the setpoint to the cruise control.

A digit is entered by “writing” (tracing) the digit onto the input field 12, i.e. by roughly tracing over the input field 12 with-the fingertip or thumb (depending on the installation site in the vehicle). The digit entered in this manner is recognized by a reading function.

According to a first embodiment variant, several digits consecutively are entered one after the other, i.e. after the first digit has been traced, it is stored and the input field 12 is ready for the entry of another digit. In a second embodiment variant, the sequence of digits is entered in a spatial arrangement. In this case, the digits are traced onto the input field 12 next to each other before the entry is completed by a confirmation movement.

The entered digits are interpreted by the reading function, which only accepts plausible entries. For instance, the digit “5”, entered by way of an example in the figure, is interpreted as a speed of 50 km/h and by the same token, the input sequence “1” followed by “2” could be interpreted as 120 km/h. In another version, the input field 12 is divided into several zones so that the entry of the number “5”—depending on the zone in which it is entered—is interpreted as a speed indication of 5 km/h (pedestrian zone, neighborhood play street), 50 km/h (town) or 135 km/h (highway).

In order to set an input speed, the control field 20 is tapped. In an alternative embodiment of the operating means, there is no separate control field 20. The reading function associated with the input field 12 then interprets a brief tap of the input field 12 after entry of the speed as a setting command.

1. An operating means for a cruise control in vehicles, comprising a touch-sensitive control panel with at least one alphanumeric input field onto which at least one digit can be entered by tracing, a digit thus entered being transmitted as a setpoint value to the cruise control by a setting function.

2. The operating means according to claim 1, wherein the setting function is activated by tapping, a control field.

3. The operating means according to claim 2, wherein the control field is contained within the alphanumeric input field.

4. The operating means according to claim 1, wherein the setting function comprises a reading function that interprets symbols that have been entered with a fingertip by roughly tracing the digit onto the alphanumeric input field and that only accepts plausible alphanumeric symbols.

5. The operating means according to claim 1, wherein the alphanumeric input field is divided into a plurality of zones, whereby at least one digit can be entered into each of the zones.

6. The operating means according to claim 1, wherein the alphanumeric input field is surrounded by a plurality of control fields that can be haptically distinguished from each other, each of which is associated with a control function.
